(19) United States
(12) Patent Application Publication
(10) Pub. No.: US 2023/0051900 A1
(43) Pub. Date: Feb. 16, 2023

(54) DISTANCE MEASUREMENT APPARATUS, MIRROR CONTROL METHOD, AND COMPUTER-READABLE RECORDING MEDIUM STORING PROGRAM

(71) Applicant: FUJITSU LIMITED, Kawasaki-shi (JP)

(72) Inventors: Arata EJIRI, Machida (JP); Yoshiaki Ikai, Fujisawa (JP); Kosuke YANAI, Kawasaki (JP); Koichi Iida, Kobe (JP)

(73) Assignee: FUJITSU LIMITED, Kawasaki-shi (JP)

(21) Appl. No.: 17/978,256

(22) Filed: Nov. 1, 2022

Related U.S. Application Data
(63) Continuation of application No. PCT/JP2020/021827, filed on Jun. 2, 2020.

(51) Int. Cl. G01S 7/481; G01S 17/89; G02B 26/10; G02B 26/08

(52) U.S. Cl. CPC G01S 7/4817; G01S 17/89; G02B 26/101; G02B 26/0833

(57) ABSTRACT

A distance measurement apparatus of a scanning type provided with a two-dimensional micro electro mechanical system (MEMS) mirror that reflects a laser beam includes: a first detector that detects a mirror angle of the two-dimensional MEMS mirror and outputs an angular signal that indicates the mirror angle; and a processor that calculates an amplitude error and a phase error between amplitude and a phase of the angular signal and amplitude and a phase of a reference angle signal, and corrects a resonance drive waveform of a drive signal that drives, of two mutually orthogonal axes of the two-dimensional MEMS mirror, one axis on a resonance drive side on a basis of the amplitude error and the phase error.

### CROSS-REFERENCE TO RELATED APPLICATION

This application is a continuation application of International Application PCT/JP2020/021827 filed on Jun. 2, 2020 and designated the U.S., the entire contents of which are incorporated herein by reference.

### FIELD

The embodiments discussed herein are related to a distance measurement apparatus, a mirror control method, and a program.

### BACKGROUND

A scanning-type distance measurement apparatus using a laser beam is also referred to as a laser radar, a laser sensor, or the like. The scanning-type distance measurement apparatus reflects a laser beam by, for example, a two-dimensional micro electro mechanical system (MEMS) mirror and two-dimensionally scans a measurement object so that a distance to the measurement object may be measured.

Japanese Laid-open Patent Publication No. 2016-085279, Japanese Laid-open Patent Publication No. 2017-203840, and Japanese Laid-open Patent Publication No. 2018-101040 are disclosed as related art.

### SUMMARY

According to an aspect of the embodiments, a distance measurement apparatus of a scanning type provided with a two-dimensional micro electro mechanical system (MEMS) mirror that reflects a laser beam includes: a first detector that detects a mirror angle of the two-dimensional MEMS mirror and outputs an angular signal that indicates the mirror angle; and a processor that calculates an amplitude error and a phase error between amplitude and a phase of the angular signal and amplitude and a phase of a reference angle signal, and corrects a resonance drive waveform of a drive signal that drives, of two mutually orthogonal axes of the two-dimensional MEMS mirror, one axis on a resonance drive side on a basis of the amplitude error and the phase error.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram illustrating an exemplary case where amplitude of an x-axis drive signal changes from a state indicated by a solid line to a state indicated by a broken line according to a change in resonance frequency fₓ;

FIG. 1B is a diagram illustrating image distortion caused by the amplitude fluctuation in FIG. 1A;

FIG. 2A is a diagram illustrating an exemplary case where a phase of the x-axis drive signal changes from a state indicated by a solid line to a state indicated by a broken line according to a change in the resonance frequency fₓ;

FIG. 2B is a diagram illustrating the image distortion caused by the phase fluctuation in FIG. 2A;

FIG. 3 is a diagram illustrating an exemplary distance measurement apparatus according to an embodiment;

FIG. 4 is a block diagram illustrating an exemplary computer;

FIG. 5 is a diagram illustrating an exemplary housing of the distance measurement apparatus;

FIG. 6 is a diagram illustrating an exemplary drive signal having a resonance drive waveform;

FIG. 7 is a diagram illustrating an exemplary drive signal having a non-resonance drive waveform;

FIG. 8 is a flowchart for explaining an exemplary distance measurement process;

FIG. 9 is a diagram for explaining measurement of an amplitude difference of resonance drive waveforms;

FIG. 10 is a diagram for explaining measurement of a phase difference of the resonance drive waveforms;

FIG. 11 is a functional block diagram illustrating an exemplary amplitude/phase correction circuit according to a first embodiment;

FIG. 12 is a flowchart for explaining an amplitude/phase correction process according to the first embodiment;

FIG. 13 is a diagram illustrating an exemplary relationship between a horizontal direction angle and a horizontal direction drive waveform;

FIG. 14 is a diagram illustrating exemplary screen scanning;

FIG. 15 is a functional block diagram illustrating an exemplary amplitude/phase correction circuit according to a second embodiment;

FIG. 16 is a diagram illustrating an exemplary temperature correction table;

FIG. 17 is a flowchart for explaining an amplitude/phase correction process according to the second embodiment; and

FIG. 18 is a diagram for explaining amplitude correction and phase correction when an image fluctuates.

### DESCRIPTION OF EMBODIMENTS

The scanning-type distance measurement apparatus may be applied to sensing of a person, an object, a space, or the like, and in the case of such an application, it is desirable to perform sensing in real time and with high resolution. Furthermore, the scanning-type distance measurement apparatus may also be applied to generation of three-dimensional data and distance images with no occlusion by, for example, simultaneously measuring an exercising person from a plurality of directions. The three-dimensional data and the distance images may be used for, for example, scoring artistic gymnastics and the like.

It is desirable that a scanning speed of a laser beam by the two-dimensional MEMS mirror is high and an angle of view of the scanning by the laser beam is large. Meanwhile, while it is conceivable to increase a laser emission repetition speed to perform sensing of a measurement object with high resolution, this measure has limitations. In view of the above, a technique has been proposed in which an angle of view is reduced and a center angle of a scanning angle range by a laser beam is shifted to follow a measurement object.

Moreover, a technique has also been proposed in which, in order to expand a scanning angle range by a laser beam while maintaining measurement resolution, an angle of view is dynamically controlled according to movement of a measurement object to change the scanning angle range. The two-dimensional MEMS mirror is driven by drive signals having a sinusoidal wave drive waveform using resonance on, of two mutually orthogonal axes of the two-dimensional MEMS mirror that reflects a laser beam, one axis on a resonance drive side and a sawtooth waveform on the other axis on a non-resonance drive side that controls an angle of view. The scanning angle of view by the laser beam is, for example, fixed on the resonance drive side of the two-dimensional MEMS mirror in the horizontal direction, and may be dynamically controlled on the non-resonance drive side of the two-dimensional MEMS mirror in the vertical direction.

On the resonance drive side of the two-dimensional MEMS mirror, a resonance frequency of the drive signal fluctuates depending on a temperature and a position within a screen, and fluctuates when the angle of view of is changed. Such fluctuations in the resonance frequency of the drive signal causes screen distortion.

In an existing scanning-type distance measurement apparatus equipped with the two-dimensional MEMS mirror, it is difficult to suppress the screen distortion as the resonance frequency of the drive signal fluctuates on the resonance drive side of the two-dimensional MEMS mirror.

In view of the above, in one aspect, it is aimed to provide a distance measurement apparatus, a mirror control method, and a program capable of suppressing screen distortion caused by a fluctuation in a resonance frequency of a drive signal on a resonance drive side of a scanning-type distance measurement apparatus equipped with a two-dimensional MEMS mirror.

In a disclosed distance measurement apparatus, mirror control method, and program, a two-dimensional MEMS mirror that reflects a laser beam is driven by a drive signal having a resonance drive waveform such as a sinusoidal wave using resonance on one axis on a resonance drive side out of two mutually orthogonal axes of the two-dimensional MEMS mirror. The two-dimensional MEMS mirror is driven by a drive signal having a non-resonance drive waveform such as a sawtooth waveform on the other axis on a non-resonance drive side that controls an angle of view. Hereinafter, the resonance drive side will be described unless otherwise specified. An amplitude error and a phase error between amplitude and a phase of an angular signal indicating a mirror angle of the two-dimensional MEMS mirror and amplitude and a phase of a reference angle signal are calculated, and the resonance drive waveform of the drive signal that drives the two-dimensional MEMS mirror is corrected on the basis of the amplitude error and the phase error.

Hereinafter, each embodiment of the disclosed distance measurement apparatus, mirror control method, and program will be described with reference to the drawings.

### EMBODIMENTS

On the resonance drive side of the two-dimensional MEMS mirror, a resonance frequency fₓ of the drive signal fluctuates depending on a temperature and a position within a screen, and fluctuates when the angle of view of is changed. For example, the resonance frequency fₓ of the drive signal changes depending on a temperature and the like. In the case of a single distance measurement apparatus, the amplitude and phase of the drive signal may be maintained constant by changing a drive frequency f_{d} of the drive signal according to the resonance frequency fₓ. Meanwhile, when the drive frequency f_{d} is maintained constant as in the case of synchronously operating a plurality of distance measurement apparatuses, for example, the amplitude and phase of the drive signal fluctuate according to a change in temperature and the like. Screen distortion occurs when the amplitude and phase of the drive signal fluctuate.

Furthermore, since drive system structures of the two mutually orthogonal axes (e.g., x-axis and y-axis) of the two-dimensional MEMS mirror are integrated and affect each other, for example, the resonance frequency fₓ of the x-axis drive signal in the horizontal direction fluctuates according to a y-axis position in the vertical direction on the non-resonance drive side. Accordingly, even within the same screen, the amplitude and phase of the x-axis drive signal fluctuate at the top, center, and bottom of the screen, resulting in screen distortion.

Moreover, for example, in a case of dynamically changing the angle of view by changing a scanning angle range of a laser beam according to movement of a measurement object, the resonance frequency fₓ largely fluctuates, and screen distortion occurs before and after the change in the angle of view.

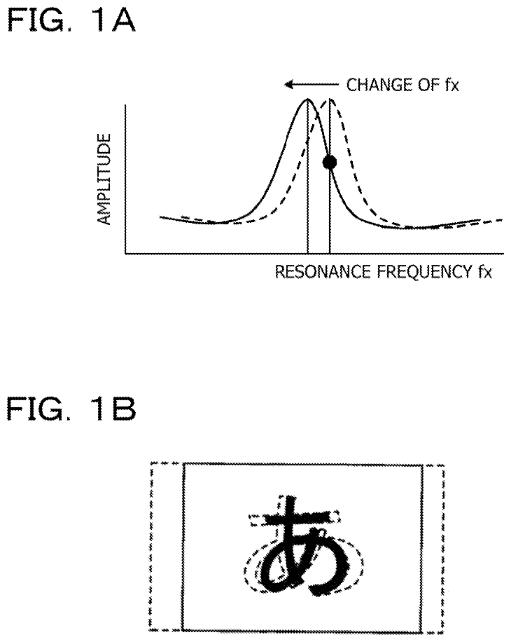

FIG. 1A illustrates an exemplary case where the amplitude of the x-axis drive signal changes from a state indicated by a solid line to a state indicated by a broken line according to a change (or fluctuation) in the resonance frequency fₓ, and FIG. 1B illustrates image distortion caused by the amplitude fluctuation. In FIG. 1B, the state indicated by the broken line and gray corresponds to the state indicated by the broken line in FIG. 1A. In this example, the image illustrated in FIG. 1B extends in the horizontal direction as indicated by the broken line, and the pattern in the image also extends in the horizontal direction as indicated in gray.

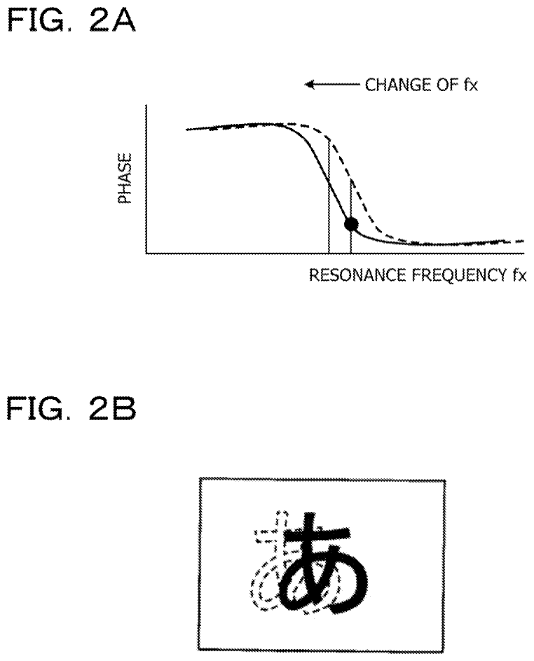

FIG. 2A illustrates an exemplary case where the phase of the x-axis drive signal changes from a state indicated by a solid line to a state indicated by a broken line according to a change in the resonance frequency fₓ, and FIG. 2B illustrates image distortion caused by the phase fluctuation. In FIG. 2B, the state indicated in gray corresponds to the state indicated by the broken line in FIG. 2A. In this example, the pattern in the image illustrated in FIG. 2B is displaced in the horizontal direction as indicated in gray.

The resonance frequency fₓ of the x-axis drive signal fluctuates depending on the temperature and the position within the screen, and fluctuates when the angle of view is changed. In view of the above, it is conceivable to stabilize the screen by performing feedback control of the mirror angle of the two-dimensional MEMS mirror. However, in order to perform the feedback control of the two-dimensional MEMS mirror driven at a high drive frequency of 28 kHz, for example, a control system needs to perform control at a frequency tenfold (e.g., 280 kHz) or higher than the drive frequency. Furthermore, a control system that performs control at such a high frequency needs to include an expensive computer with a high operating frequency or the like, which is not practical.

Thus, in view of the above, each embodiment of the distance measurement apparatus, mirror control method, and program to be described below has a configuration of reducing the screen distortion by maintaining the drive frequency f_{d} constant without changing it and controlling the amplitude and phase of the drive signal. Furthermore, according to this configuration, the amplitude and phase of the drive signal are detected and fed back individually, whereby the control system does not need to include an expensive computer with a high operating frequency or the like.

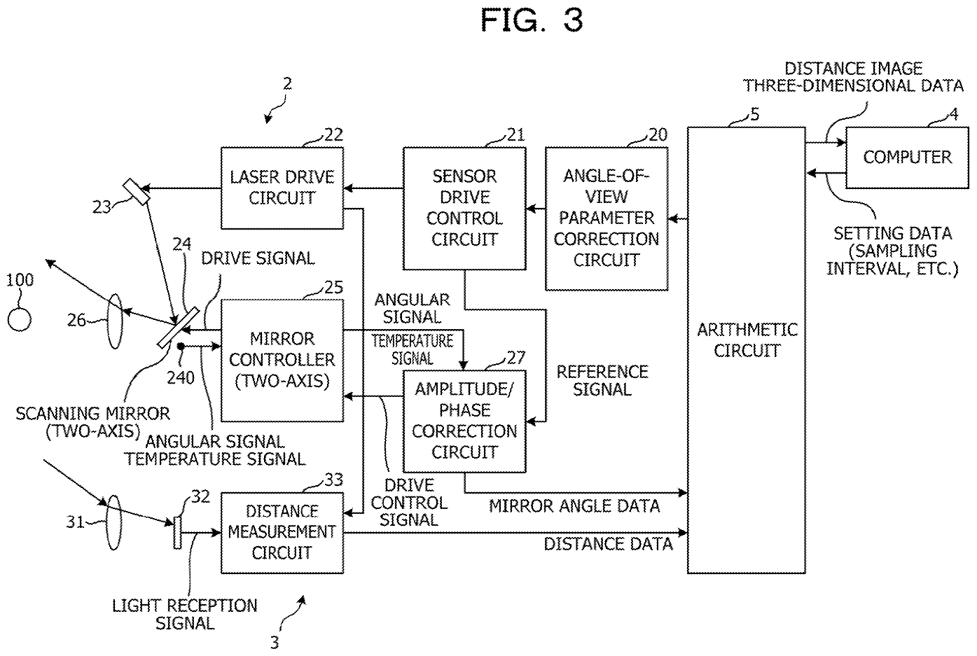

FIG. 3 is a diagram illustrating an exemplary distance measurement apparatus according to an embodiment. The scanning-type distance measurement apparatus illustrated in FIG. 3 includes an apparatus main body 1 and a computer 4. The apparatus main body 1 includes a light projecting unit 2, a light receiving unit 3, and an arithmetic circuit 5. When a distance measurement process starts, the computer 4 supplies, to the arithmetic circuit 5 of the apparatus main body 1, setting data including a sampling interval (or sampling density), an azimuth angle to a measurement object 100, and the like. The azimuth angle to the measurement object 100 will be described later.

The light projecting unit 2 includes an angle-of-view parameter correction circuit 20, a sensor drive control circuit 21, a laser drive circuit 22, a laser diode 23, a two-dimensional MEMS mirror 24, a two-axis mirror controller 25, an amplitude/phase correction circuit 27, and a light projecting lens 26. The laser diode 23 is an exemplary laser light source. The two-dimensional MEMS mirror 24 is an exemplary two-axis scanning mirror. As will be described later, the angle-of-view parameter correction circuit 20 corrects an angle-of-view parameter (or angle-of-view control amount) including a scanning angle range and a shift angle output by the arithmetic circuit 5, and supplies it to the sensor drive control circuit 21. The sensor drive control circuit 21 supplies a light emission timing signal indicating light emission timing of the laser diode 23 to the laser drive circuit 22.

The laser drive circuit 22 causes the laser diode 23 to emit light at the light emission timing indicated by the light emission timing signal. Furthermore, the sensor drive control circuit 21 supplies a drive control signal for controlling biaxial drive of the two-dimensional MEMS mirror 24 to the mirror controller 25 via the amplitude/phase correction circuit 27. As will be described later, the amplitude/phase correction circuit 27 calculates an amplitude error and a phase error between a mirror angle signal obtained via the mirror controller 25 and a reference angle signal to be reference of a mirror angle signal obtained from the sensor drive control circuit 21. Furthermore, the amplitude/phase correction circuit 27 generates a drive control signal for correcting the resonance drive waveform of the drive signal for driving the two-dimensional MEMS mirror 24 on the basis of the amplitude error and the phase error. For example, the amplitude/phase correction circuit 27 is an exemplary correction circuit that calculates the amplitude error and the phase error between the mirror angle signal and the reference angle signal and corrects the resonance drive waveform of the drive signal for driving the axis of the two-dimensional MEMS mirror 24 on the resonance drive side on the basis of the amplitude error and the phase error.

The mirror controller 25 outputs a drive signal for biaxially driving the two-dimensional MEMS mirror 24 according to the drive control signal to drive the two-dimensional MEMS mirror 24 with a well-known drive unit (not illustrated) including a piezoelectric element and the like. For example, a sinusoidal drive signal, which is an exemplary non-linear resonance drive waveform, is used for driving the two-dimensional MEMS mirror 24 in the horizontal direction, and a sawtooth drive signal, which is an exemplary linear non-resonance drive waveform, is used for driving the two-dimensional MEMS mirror 24 in the vertical direction orthogonal to the horizontal direction.

A well-known angle detection unit (not illustrated) detects a mirror angle of the two-dimensional MEMS mirror 24. The angle detection unit supplies a mirror angle signal indicating a mirror angle (hereinafter also simply referred to as “angular signal”) to the mirror controller 25. Furthermore, a well-known temperature detection unit (not illustrated) detects a mirror temperature of the two-dimensional MEMS mirror 24. The temperature detection unit supplies a mirror temperature signal indicating a mirror temperature (hereinafter also simply referred to as “temperature signal”) to the mirror controller 25. In FIG. 3, the two-dimensional MEMS mirror 24 is illustrated with a reference sign 240 in a form including the drive unit, the angle detection unit, and the temperature detection unit described above for convenience of explanation. For example, in this example, the two-dimensional MEMS mirror 24 is a MEMS mirror module in which the drive unit, the angle detection unit, and the temperature detection unit described above are incorporated. However, it is sufficient if the angle detection unit and the temperature detection unit are provided at positions near the two-dimensional MEMS mirror 24 where the mirror angle and the mirror temperature may be detected, for example.

Furthermore, the amplitude/phase correction circuit 27 generates mirror angle data indicating the mirror angle of the two-dimensional MEMS mirror 24 according to the angular signal, and supplies it to the arithmetic circuit 5. With this arrangement, a laser beam emitted from the laser diode 23 is reflected (or deflected) by the two-dimensional MEMS mirror 24, and performs scanning of the scanning angle range through the light projecting lens 26, which is, for example, raster scanning. For example, an angle magnifying lens may be used as the light projecting lens 26. Note that the temperature detection unit may be omitted in a first embodiment to be described later, and the temperature detection unit will be described together with a second embodiment to be described later.

By such raster scanning, the laser beam (or laser pulse) scans the scanning angle range at a position a certain distance away from the apparatus main body 1. The position a certain distance away from the apparatus main body 1 is, for example, a position of the measurement object 100. The scanning angle range has a width corresponding to a distance in which the laser beam moves from one end to the other end of the scanning angle range substantially parallel to a horizontal plane (or a ground surface), for example, at the position a certain distance away from the apparatus main body 1. Furthermore, the scanning angle range is equal to an angle of view of scanning by the laser beam, and refers to an angle at which the laser beam scans in the horizontal direction and an angle at which the laser beam scans in the vertical direction regardless of the distance from the apparatus main body 1. Note that, for convenience of explanation, it is assumed that the angle of view of scanning by the laser beam may be dynamically controlled on the non-resonance drive side of the two-dimensional MEMS mirror 24 in the vertical direction, and is fixed on the resonance drive side in the horizontal direction.

The light receiving unit 3 includes a light receiving lens 31, a photodetector 32, and a distance measurement circuit 33. Reflected light from the measurement object 100 is detected by the photodetector 32 through the light receiving lens 31. For example, a condensing lens may be used as the light receiving lens 31. The photodetector 32 is, for example, a light receiving element that supplies a light reception signal representing the detected reflected light to the distance measurement circuit 33. The distance measurement circuit 33 measures a Time Of Flight (TOF) ΔT from when the laser beam is emitted from the light projecting unit 2 until when the laser beam is reflected by the measurement object 100 and returns to the light receiving unit 3. Note that the timing at which the light projecting unit 2 emits the laser beam is notified from the laser drive circuit 22 to the distance measurement circuit 33 according to the drive timing of the laser diode 23 by the laser drive circuit 22. As a result, the distance measurement circuit 33 optically measures the distance to the measurement object 100, and supplies distance data indicating the measured distance to the arithmetic circuit 5. When a light speed is represented by c (approximately 300,000 km/s), the distance to the measurement object 100 may be obtained from (c×ΔT)/2, for example.

The arithmetic circuit 5 generates a distance image and three-dimensional data on the basis of the mirror angle data from the amplitude/phase correction circuit 27 and the distance data from the distance measurement circuit 33. For example, the arithmetic circuit 5 generates the distance image from the distance data, and generates the three-dimensional data from the distance image and the mirror angle data. The distance image is an image in which distance values at respective ranging points are arranged in the order of raster scanning sampling. Furthermore, the arithmetic circuit 5 may generate light projection angle data indicating a light projection angle of a laser beam for each sample from the mirror angle data, or may retain the light projection angle data as a table. The three-dimensional data may be generated by converting the distance image using the distance value and the light projection angle data, and includes information regarding the distance to the measurement object 100 and the light projection angle of the laser beam for each sample.

The distance image and the three-dimensional data are supplied from the arithmetic circuit 5 to the computer 4. The computer 4 may perform, for example, a process of extracting the measurement object 100, a process of calculating the azimuth angle to the measurement object 100, and the like on the basis of the distance image and the three-dimensional data. A method of extracting the measurement object 100 from the distance image is not particularly limited, and for example, when the measurement object 100 is a person, the measurement object 100 may be extracted by detecting a shape such as a posture that may be taken by the person from the distance image by a well-known method. Furthermore, the azimuth angle to the measurement object 100 may be calculated by a well-known method from the extracted measurement object 100 and information regarding the light projection angle of the three-dimensional data.

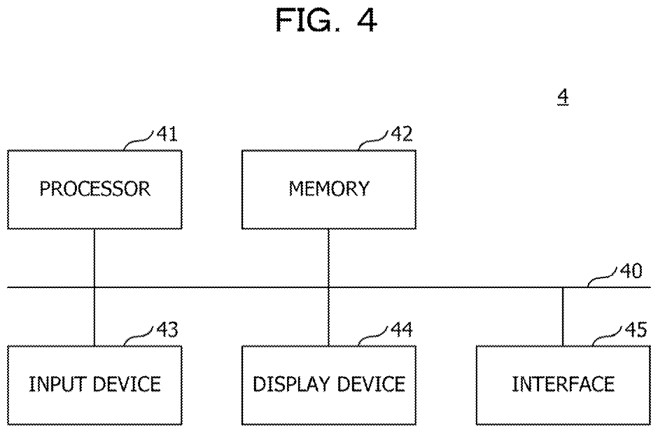

FIG. 4 is a block diagram illustrating an exemplary computer. The computer 4 illustrated in FIG. 4 includes a processor 41, a memory 42, an input device 43, a display device 44, and an interface (or communication device) 45, which are mutually connected via a bus 40. The processor 41 may be formed by, for example, a central processing unit (CPU) or the like, and executes a program stored in the memory 42 to take overall control of the computer 4. The memory 42 may be formed by a computer-readable storage medium. The computer-readable storage medium includes, for example, a non-transitory computer-readable storage medium such as a semiconductor storage device, a magnetic recording medium, an optical recording medium, a magneto-optical recording medium, or the like. The memory 42 stores various programs including a distance measurement program to be executed by the processor 41, various types of data, various tables, and the like.

The input device 43 may be formed by, for example, a keyboard operated by a user (or operator), and is used to input commands, data, and the like to the processor 41. The display device 44 is used to display a message to a user, a measurement result of the distance measurement process, and the like. The interface 45 communicably connects the computer 4 with another computer and the like. In this example, the computer 4 is connected to the arithmetic circuit 5 via the interface 45.

Note that the computer 4 is not limited to have the hardware configuration in which the components of the computer 4 are connected via the bus 40. Furthermore, for example, a personal computer (PC) or a general-purpose computer may be used as the computer 4.

The input device 43 and the display device 44 of the computer 4 may be externally connected, and may be omitted. Furthermore, in the case of a module, a semiconductor chip, or the like in which the interface 45 of the computer 4 is omitted, an output of the apparatus main body 1 (e.g., output of the arithmetic circuit 5) may be connected to the bus 40 or may be directly connected to the processor 41.

For example, a semiconductor chip or the like incorporating the computer 4 may be provided inside the apparatus main body 1. In this case, the computer 4 may include at least a part of the functions of the arithmetic circuit 5, the angle-of-view parameter correction circuit 20, the sensor drive control circuit 21, the amplitude/phase correction circuit 27, and the distance measurement circuit 33, for example.

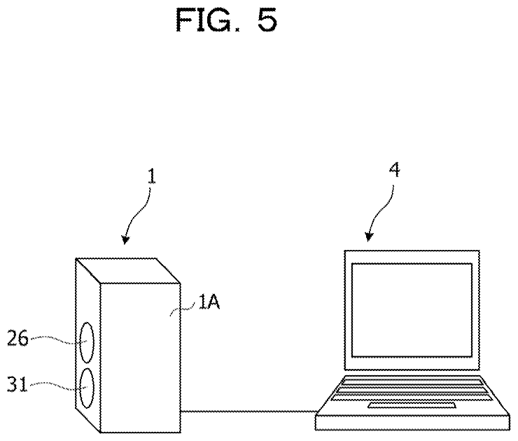

FIG. 5 is a diagram illustrating an exemplary housing of the distance measurement apparatus. In FIG. 5, for convenience of explanation, an exemplary case where the apparatus main body 1 of the distance measurement apparatus is connected to the computer 4 is illustrated. The apparatus main body 1 includes a housing 1A, and the light projecting unit 2, the light receiving unit 3, the arithmetic circuit 5, and the like are housed in the housing 1A. In this example, the light projecting lens 26 of the light projecting unit 2 and the light receiving lens 31 of the light receiving unit 3 are arranged on one side surface side of the housing 1A.

Note that the computer 4 may be a separate body from the distance measurement apparatus. In this case, the distance measurement apparatus may include only the apparatus main body 1, and the computer 4 may be formed by, for example, a cloud computing system or the like.

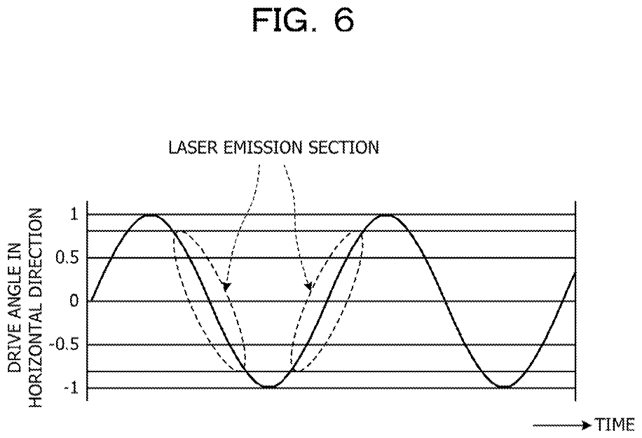

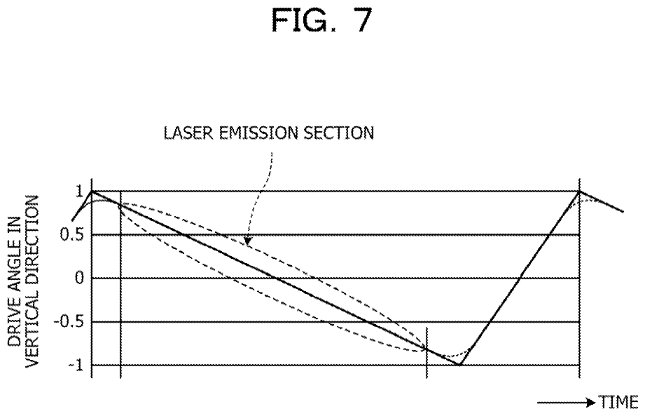

In the present embodiment, a drive signal having a sinusoidal wave (e.g., drive current or drive voltage), which is an exemplary non-linear resonance drive waveform illustrated in FIG. 6, is used for driving the two-dimensional MEMS mirror 24 in the horizontal direction. In FIG. 6, the vertical axis represents a drive angle in the horizontal direction in an optional unit, and the horizontal axis represents a time in an optional unit. Furthermore, a drive signal having a sawtooth wave (e.g., drive current or drive voltage), which is an exemplary linear non-resonance drive waveform illustrated in FIG. 7, is used for driving the two-dimensional MEMS mirror 24 in the vertical direction orthogonal to the horizontal direction. In FIG. 7, the vertical axis represents a drive angle in the vertical direction in an optional unit, and the horizontal axis represents a time in an optional unit. In FIGS. 6 and 7, a broken line indicates a laser emission section, which is an emission section of the laser diode 23.

The amplitude/phase correction circuit 27 has functions of calculating an amplitude error and a phase error between the amplitude and phase of the angular signal indicating the mirror angle of the two-dimensional MEMS mirror 24 and the amplitude and phase of the reference angle signal, and correcting (or modifying) the drive control signal on the basis of the amplitude error and the phase error. Furthermore, in a case where the temperature signal indicating the mirror temperature of the two-dimensional MEMS mirror 24 is obtained, the amplitude/phase correction circuit 27 may calculate the amplitude error after correcting (or modifying) the amplitude of the angular signal on the basis of the temperature signal. In this manner, the amplitude/phase correction circuit 27 causes the mirror controller 25 to output the drive signal having the resonance drive waveform corrected for driving the two-dimensional MEMS mirror 24 in the horizontal direction. For example, the amplitude/phase correction circuit 27 has a function of correcting (or modifying) the drive signal having the resonance drive waveform output by the mirror controller 25 by correcting (or modifying) the drive control signal on the basis of the amplitude error and the phase error.

While the amplitude/phase correction circuit 27 causes the mirror controller 25 to output the drive signal having the non-resonance drive waveform for driving the two-dimensional MEMS mirror 24 in the vertical direction, driving by such a drive signal having the non-resonance drive waveform itself is well known, and descriptions thereof is omitted.

Note that the drive signal having the non-resonance drive waveform may be used for driving the two-dimensional MEMS mirror 24 in the horizontal direction, and the drive signal having the resonance drive waveform may be used for driving the two-dimensional MEMS mirror 24 in the vertical direction. Furthermore, the distance measurement apparatus may have an arrangement inclined at any angle relative to the horizontal plane, for example, which is not parallel to the horizontal plane.

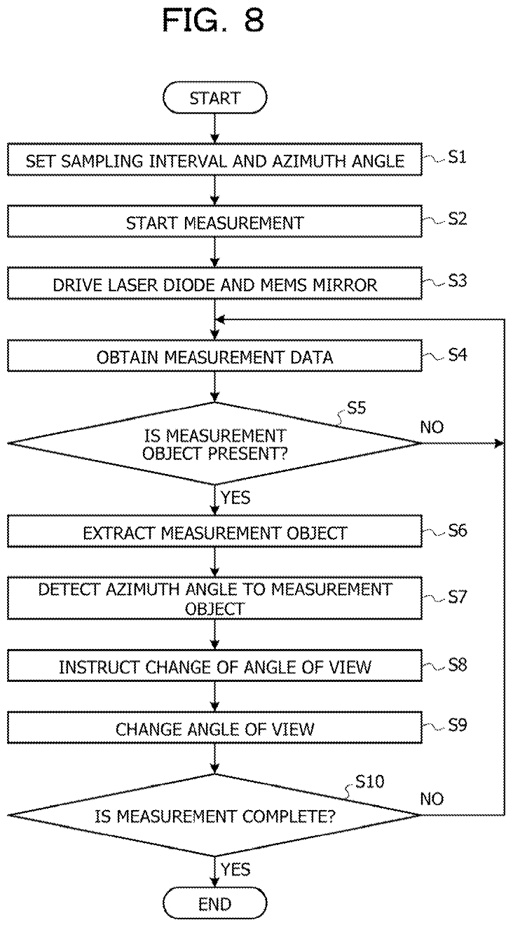

FIG. 8 is a flowchart for explaining an exemplary distance measurement process. The distance measurement process is started by, for example, the processor 41 of the computer 4 executing the distance measurement program stored in the memory 42.

In FIG. 8, for example, when the distance measurement process starts in response to a command input from the input device 43, in step S1, the computer 4 sets setting data including a sampling interval and an azimuth angle to the measurement object 100 and the like in the arithmetic circuit 5 of the apparatus main body 1.

In step S2, the computer 4 causes the arithmetic circuit 5 of the apparatus main body 1 to start measurement of a distance at a distance measurement timing according to the setting data.

In step S3, the computer 4 causes the arithmetic circuit 5 of the apparatus main body 1 to drive the laser diode 23 through the angle-of-view parameter correction circuit 20, the sensor drive control circuit 21, and the laser drive circuit 22 at a drive timing according to the setting data. Furthermore, in step S3, the computer 4 causes the arithmetic circuit 5 of the apparatus main body 1 to drive the drive unit of the two-dimensional MEMS mirror 24 through the angle-of-view parameter correction circuit 20, the amplitude/phase correction circuit 27, and the mirror controller 25 at a drive timing according to the setting data.

In step S4, the computer 4 obtains measurement data including the distance image, the three-dimensional data, and the like from the arithmetic circuit 5 of the apparatus main body 1. In step S5, the computer 4 determines whether or not the measurement object 100 is present on the basis of the three-dimensional data and the distance image of the measurement data, and the process returns to step S4 when the determination result is No while the process proceeds to step S6 when the determination result is Yes. It is possible to determine whether or not the measurement object 100 is present within the scanning angle range subjected to the raster scanning by a well-known method. For example, when the measurement object 100 is a person, the presence of the measurement object 100 may be determined by detecting a shape of a posture of the person, a skin color of the face of the person, and the like from the distance image. Furthermore, a method may be adopted in which the generated three-dimensional data or distance image is displayed on the display device 44 of the computer 4, and in a case where the user specifies (clicks) a desired position or range of a display screen with the input device 43 such as a mouse, the measurement object 100 is determined to be present, or the like.

In step S6, since the measurement object 100 is present within the scanning angle range subjected to the raster scanning, the computer 4 extracts the measurement object 100 detected from the distance image by a well-known method, for example, and obtains object data of the extracted measurement object 100. In step S7, the computer 4 calculates an azimuth angle to the measurement object 100 from, for example, the extracted object data and the information regarding the light projection angle of the three-dimensional data by a well-known method, and stores it in the memory 42 as needed.

In step S8, the arithmetic circuit 5 of the apparatus main body 1 calculates a setting value of each of the scanning angle range, a center angle of the scanning angle range, and a shift angle so as to be the azimuth angle to the measurement object 100 included in the setting data from the computer 4. In step S8, the arithmetic circuit 5 of the apparatus main body 1 outputs an angle-of-view change instruction and the setting value of each of the scanning angle range, the center angle of the scanning angle range, and the shift angle to the angle-of-view parameter correction circuit 20, and instructs change of an angle of view when the angle of view is dynamically controlled.

In step S9, the angle-of-view parameter correction circuit 20 of the apparatus main body 1 changes the angle of view in accordance with the angle-of-view change instruction from the arithmetic circuit 5. For example, the angle-of-view parameter correction circuit 20 outputs a correction offset amount to be described later to the mirror controller 25 together with a drive control signal to drive the two-dimensional MEMS mirror 24.

Note that the angle-of-view change process in steps S8 and S9 may start by, for example, a processor forming the arithmetic circuit 5 and the angle-of-view parameter correction circuit 20 executing an angle-of-view change program stored in the memory. Furthermore, in a case where the computer 4 includes the functions of the arithmetic circuit 5 and the angle-of-view parameter correction circuit 20, it is sufficient if the computer 4 executes the angle-of-view change process in steps S8 and S9.

In step S10, the computer 4 determines whether or not the distance measurement process is complete, and the process returns to step S4 when the determination result is No while the process is terminated when the determination result is Yes.

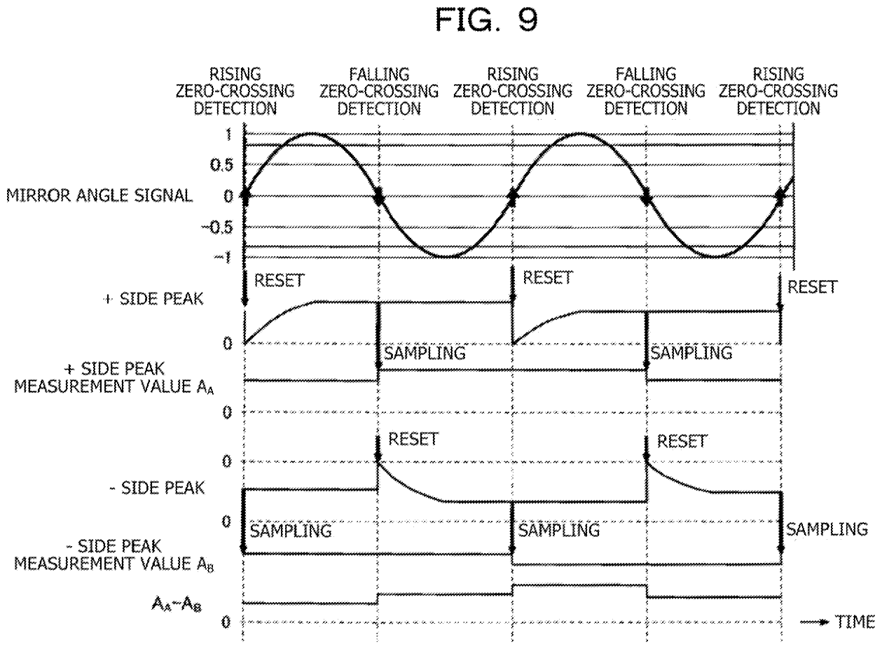

FIG. 9 is a diagram for explaining measurement of an amplitude difference of resonance drive waveforms. In this example, the resonance drive waveform of the mirror angle signal is a sinusoidal waveform. FIG. 9 illustrates a mirror angle signal, a positive (+) side peak, a + side peak measurement value A_{A}, a negative (−) side peak, a − side peak measurement value A_{B}, and an amplitude A_{A}−A_{B}. Detection of the + side peak is reset at a timing of detecting rising zero crossing of the mirror angle signal, and the + side peak measurement value A_{A} is a value obtained by sampling the + side peak at a timing of detecting falling zero crossing of the mirror angle signal. On the other hand, detection of the − side peak is reset at a timing of detecting falling zero crossing of the mirror angle signal, and the − side peak measurement value A_{B} is a value obtained by sampling the − side peak at a timing of detecting rising zero crossing of the mirror angle signal. The amplitude A_{A}−A_{B} is an amplitude measurement value obtained by subtracting the − side peak measurement value A_{B} from the + side peak measurement value A_{A}. In this manner, the amplitude A_{A}−A_{B} corresponding to a peak-to-peak value of the mirror angle signal is obtained for each cycle of the mirror angle signal. It is also possible to obtain the amplitude measurement value corresponding to the amplitude A_{A}−A_{B} for the reference angle signal in a similar manner to the case of the mirror angle signal. Then, the amplitude error of those signals may be obtained from the amplitude of the mirror angle signal and the amplitude of the reference angle signal.

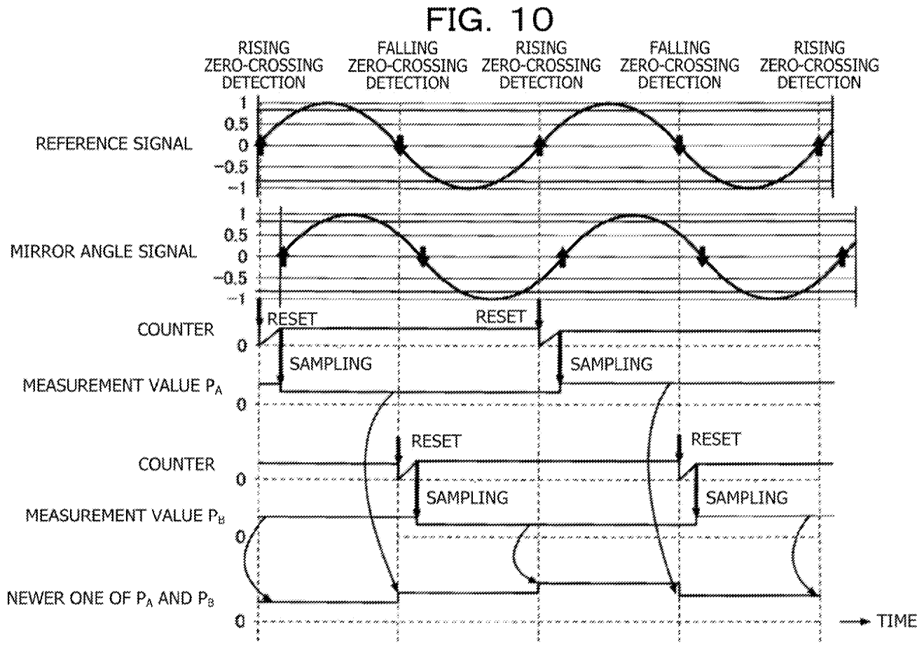

FIG. 10 is a diagram for explaining measurement of a phase difference of the resonance drive waveforms. FIG. 10 illustrates the reference angle signal (hereinafter also simply referred to as “reference signal”) that serves as a reference for the mirror angle signal, and the detected mirror angle signal. Furthermore, FIG. 10 also illustrates a delay from the rising zero crossing of the reference signal to the rising zero crossing of the detected mirror angle signal, and a delay from the falling zero crossing of the reference signal to the falling zero crossing of the detected mirror angle signal. For example, the delay from the rising zero crossing of the reference signal to the rising zero crossing of the detected mirror angle signal may be measured using a counter that is reset at a timing of detecting the rising zero crossing of the reference signal. The delay of the mirror angle signal until the rising zero crossing is represented by a measurement value P_{A} obtained by sampling the counter value of the counter at the timing of detecting the falling zero crossing of the detected mirror angle signal. Furthermore, the delay from the falling zero crossing of the reference signal to the falling zero crossing of the detected mirror angle signal may be measured by a counter that is reset at the timing of detecting the falling zero crossing of the reference signal. The delay of the mirror angle signal until the falling zero crossing is represented by a measurement value P_{B} obtained by sampling the counter value of the counter at the timing of detecting the rising zero crossing of the detected mirror angle signal. The phase error is the newer value out of the measurement value P_{A} and the measurement value P_{B} in this example. In this manner, the phase corresponding to the zero crossing of the mirror angle signal may be obtained for each cycle of the mirror angle signal, and the phase corresponding to the zero crossing of the reference signal may be obtained for each cycle of the reference signal. Then, the phase error of those signals may be obtained from the phase of the mirror angle signal and the phase of the reference signal.

In this manner, the amplitude/phase correction circuit 27 obtains first amplitude corresponding to the peak-to-peak value for each cycle of the mirror angle signal, obtains second amplitude corresponding to the peak-to-peak value for each cycle of the reference angle signal, and also obtains the amplitude error between the first amplitude and the second amplitude. Furthermore, the amplitude/phase correction circuit 27 obtains a first phase corresponding to one of the rising and falling zero crossings for each cycle of the mirror angle signal, obtains a second phase corresponding to the one of the zero crossings for each cycle of the reference angle signal, and also obtains the phase error between the first phase and the second phase.

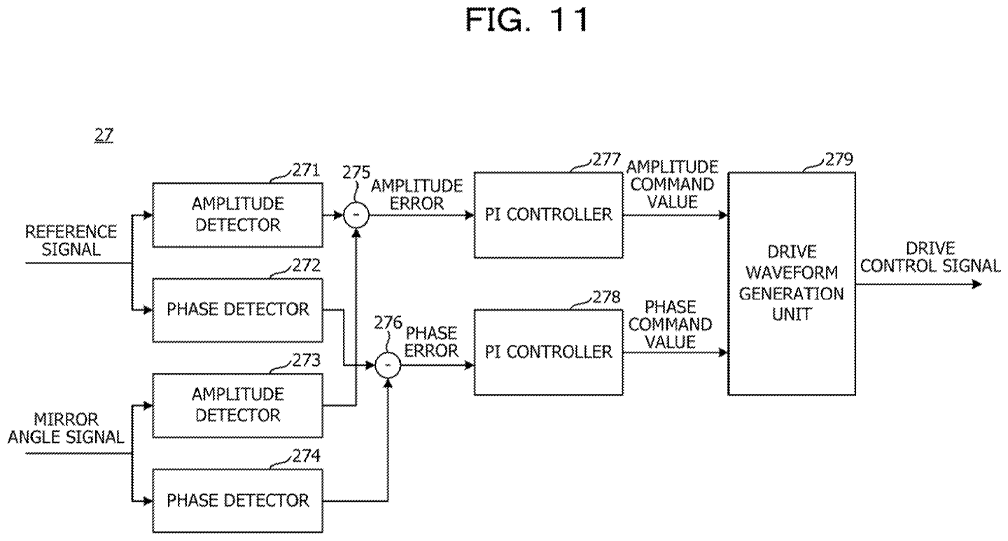

Next, a first embodiment will be described. FIG. 11 is a functional block diagram illustrating an exemplary amplitude/phase correction circuit according to the first embodiment. In the first embodiment, the amplitude/phase correction circuit 27 illustrated in FIG. 3 includes amplitude detectors 271 and 273, phase detectors 272 and 274, subtractors 275 and 276, proportional integral (PI) controller 277 and 278, and a drive waveform generation unit 279 as illustrated in FIG. 11.

A reference signal from a sensor drive control circuit 21 is input to the amplitude detector 271 and to the phase detector 272. The amplitude detector 271 detects amplitude of the reference signal by, for example, a method similar to that of FIG. 9, and the phase detector 272 detects a phase of the reference signal by, for example, the method of FIG. 10. A mirror angle signal from a detection unit is input to the amplitude detector 273 and to the phase detector 274. The amplitude detector 273 detects amplitude of the mirror angle signal by, for example, the method of FIG. 9, and the phase detector 274 detects a phase of the mirror angle signal by, for example, the method of FIG. 10.

Outputs of the amplitude detectors 271 and 273 are supplied to the subtractor 285, and an amplitude error output by the subtractor 275 is supplied to the PI controller 277. Outputs of the phase detectors 272 and 274 are supplied to the subtractor 276, and a phase error output by the subtractor 276 is supplied to the PI controller 278. The drive waveform generation unit 279 generates a drive control signal on the basis of an amplitude command value from the PI controller 277 and a phase command value from the PI controller 278, and outputs it to a mirror controller 25. The drive control signal corrects (or modifies) a resonance drive waveform of a drive signal output by the mirror controller 25 to a two-dimensional MEMS mirror 24 on the basis of the amplitude error and the phase error.

Here, when the amplitude error output by the subtractor 275 is represented by Δw, a proportional gain of the PI controller 277 is represented by K_{pw}, and an integral gain of the PI controller 277 is represented by K_{iw}, an amplitude command value R_{w} output by the PI controller 277 may be expressed by the following equation.

R_{w}=K_{pw}×Δw+K_{iw}×∫Δw

Furthermore, when the phase error output by the subtractor 276 is represented by Δh, a proportional gain of the PI controller 278 is represented by Kₚₕ, and an integral gain of the PI controller 278 is represented by Kᵢₕ, a phase command value Rₕ output by the PI controller 278 may be expressed by the following equation.

Rₕ=Kₚₕ×Δh+Kᵢₕ×∫Δh

Furthermore, the drive waveform generation unit 279 generates a drive control signal for causing the mirror controller 25 to output a drive signal D(t) expressed by the following equation to the two-dimensional MEMS mirror 24 on the basis of the amplitude command value R_{w} from the PI controller 277 and the phase command value Rₕ from the PI controller 278. In the following equation, t represents a time, f_{d} represents a drive frequency of a drive signal that drives the axis on the resonance drive side, and n represents the circular constant. The drive signal D(t) is, for example, a drive voltage.

D(t)=R_{w}×sin(2×n×f_{d}×t+Rₕ)

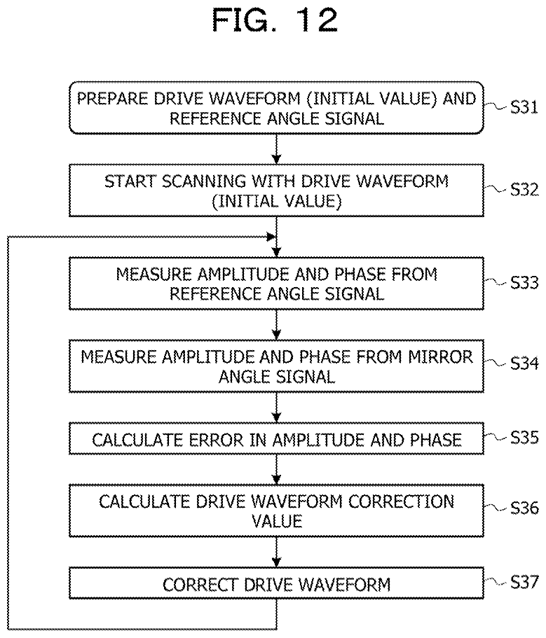

FIG. 12 is a flowchart for explaining an amplitude/phase correction process according to the first embodiment. An angle-of-view change process illustrated in FIG. 12 corresponds to the processing of step S3 in the distance measurement process illustrated in FIG. 8, and may be executed by the amplitude/phase correction circuit 27 or a processor 41 that executes the processing of the amplitude/phase correction circuit 27.

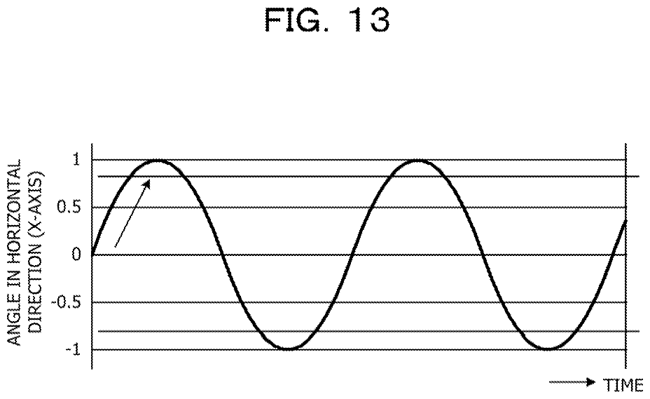

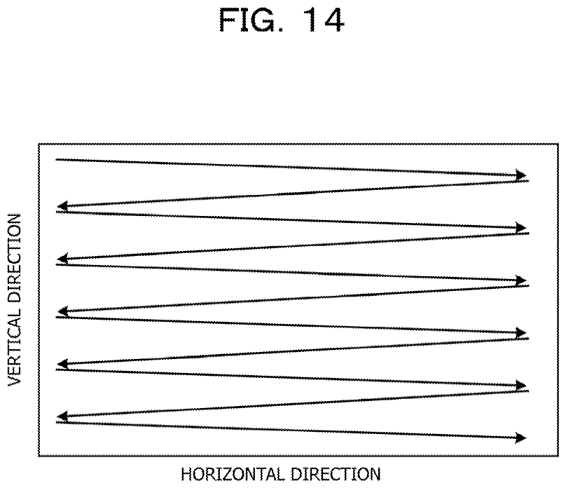

In step S31, the amplitude/phase correction circuit 27 or the processor 41 prepares a drive waveform (initial value) and a reference angle signal. FIG. 13 is a diagram illustrating an exemplary relationship between a horizontal direction angle and a horizontal direction drive waveform. In step S32, the amplitude/phase correction circuit 27 or the processor 41 starts raster scanning with the drive waveform (initial value). FIG. 14 is a diagram illustrating exemplary screen scanning, in which the vertical axis represents the vertical direction and the horizontal axis represents the horizontal direction.

In step S33, the amplitude/phase correction circuit 27 or the processor 41 measures the amplitude and phase from the reference angle signal. The processing of step S33 corresponds to the processing of the amplitude detector 271 and the phase detector 272. In step S34, the amplitude/phase correction circuit 27 or the processor 41 measures the amplitude and phase from the mirror angle signal. The processing of step S34 corresponds to the processing of the amplitude detector 273 and the phase detector 274.

In step S35, the amplitude/phase correction circuit 27 or the processor 41 calculates amplitude and phase errors between the reference angle signal and the mirror angle signal, which is, the amplitude error and the phase error. The processing of step S35 corresponds to the processing of the subtractors 275 and 276. In step S36, the amplitude/phase correction circuit 27 or the processor 41 calculates a drive waveform correction value on the basis of the amplitude error and the phase error. The processing of step S36 corresponds to the processing of the PI controllers 277 and 278. In step S37, the amplitude/phase correction circuit 27 or the processor 41 generates and outputs a drive control signal for correcting the resonance drive waveform of the drive signal output by the mirror controller 25 to the two-dimensional MEMS mirror 24 using the drive waveform correction value. The processing of step S37 corresponds to the processing of the drive waveform generation unit 279.

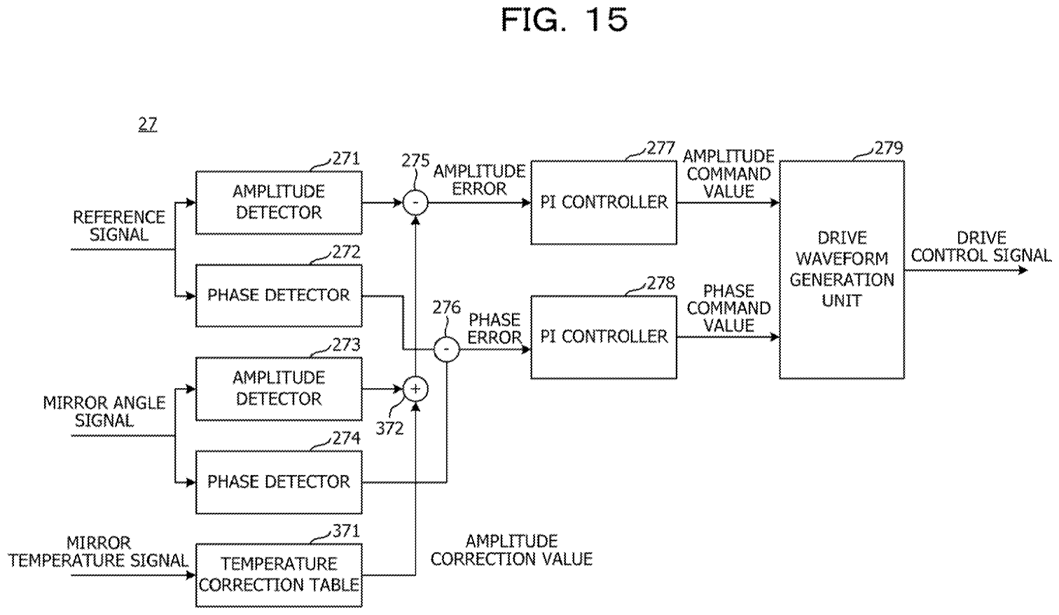

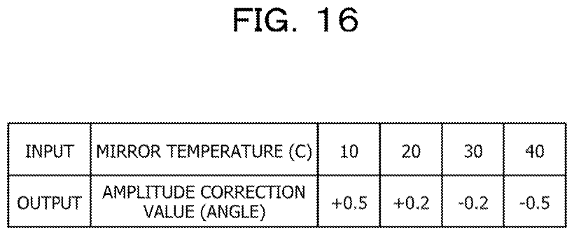

Next, a second embodiment will be described. In the second embodiment, a temperature detection unit detects a temperature of a two-dimensional MEMS mirror 24, and outputs a mirror temperature signal. FIG. 15 is a functional block diagram illustrating an exemplary amplitude/phase correction circuit according to the second embodiment. In FIG. 15, parts same as those in FIG. 11 are denoted by the same reference signs, and descriptions thereof will be omitted. In the second embodiment, the amplitude/phase correction circuit 27 illustrated in FIG. 3 includes a temperature correction table 371 and an adder 372 as illustrated in FIG. 15. FIG. 16 is a diagram illustrating an exemplary temperature correction table. The temperature correction table 371 stores amplitude correction values (angles) for input mirror temperatures. The input mirror temperature is a mirror temperature indicated by the mirror temperature signal. In this example, the temperature correction table 371 stores amplitude correction values of +0.5, +0.2, −0.2, and −0.5 for input mirror temperatures of 10° C., 20° C., 30° C., and 40° C. The temperature correction table 371 may be provided in an amplitude/phase correction circuit 27, for example, or may be stored in a memory 42 or the like.

The amplitude correction value for the input mirror temperature indicated by the mirror temperature signal is read from the temperature correction table 371, and is supplied to the adder 372. An output of an amplitude detector 273 is also supplied to the adder 372. Therefore, an output of an amplitude detector 271 and an output of the adder 372 are supplied to a subtractor 275. When the amplitude correction value for the input mirror temperature is read from the temperature correction table 371, no amplitude correction value for the matching input mirror temperature may be stored in the temperature correction table 371 of FIG. 16. In this case, the amplitude correction value for the input mirror temperature may be calculated by a well-known method such as approximation from the stored amplitude correction value for the input mirror temperature.

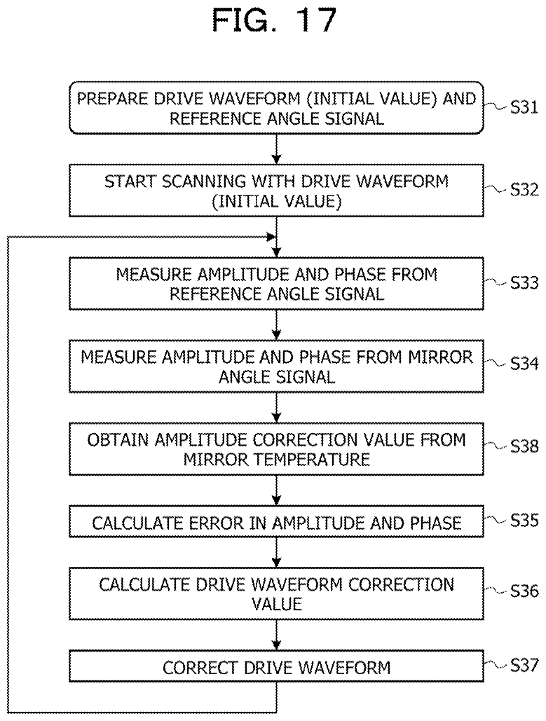

FIG. 17 is a flowchart for explaining an amplitude/phase correction process according to the second embodiment. In FIG. 17, steps same as those in FIG. 12 are denoted by the same reference signs, and descriptions thereof will be omitted. In FIG. 17, step S38 is provided between step S34 and step S35.

In step S38, the amplitude/phase correction circuit 27 or a processor 41 obtains an amplitude correction value from the mirror temperature indicated by the mirror temperature signal. The processing of obtaining the amplitude correction value in step S38 corresponds to the processing of the temperature correction table 371 and the adder 372. Accordingly, processing of calculating an amplitude error in the processing of step S35 following step S38 corresponds to the processing of the subtractor 275 that performs subtraction of the output of the adder 372 obtained by adding the amplitude correction value and the output of the amplitude detector 273 and the output of the amplitude detector 271.

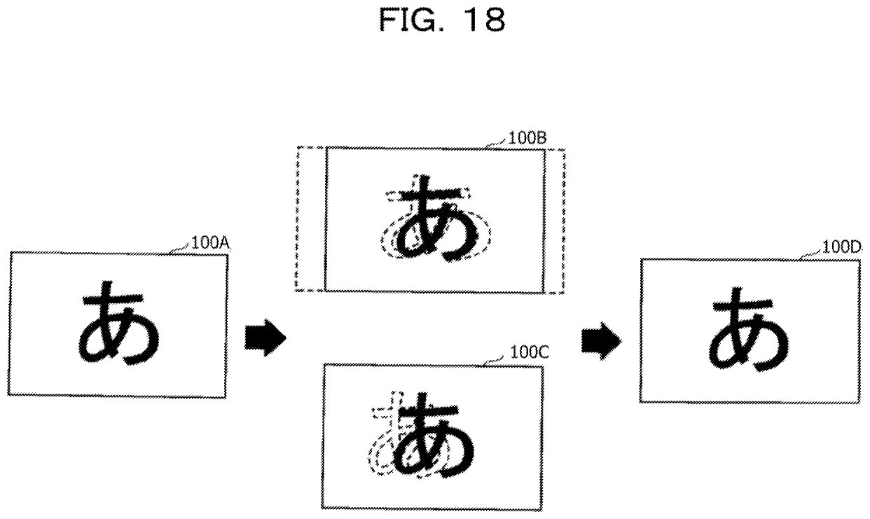

FIG. 18 is a diagram for explaining amplitude correction and phase correction when an image fluctuates. In FIG. 18, an image 100A illustrates a state in which a resonance frequency fₓ of a drive signal does not fluctuate and there is no screen distortion. An image 100B illustrates a state in which amplitude of the drive signal fluctuates due to fluctuation of the resonance frequency fₓ of the drive signal, which causes screen distortion. An image 100C illustrates a state in which a phase of the drive signal fluctuates due to fluctuation of the resonance frequency fₓ of the drive signal, which causes screen distortion. Meanwhile, an image 100D illustrates a corrected state in which distortion is suppressed by performing the amplitude/phase correction process as described in each of the embodiments above on an image in which the distortion of the image 100B, image 100C, or both image 100B and image 100C has occurred. The image 100D is substantially the same as the image 100A, and it may be confirmed that the screen distortion caused by the fluctuation of the resonance frequency fₓ of the drive signal may be reduced by maintaining a drive frequency f_{d} constant without changing it and controlling the amplitude and phase of the drive signal. Furthermore, according to each of the embodiments described above, the amplitude and phase of the drive signal are detected and fed back individually, whereby a control system does not need to include an expensive computer with a high operating frequency or the like.

The distance measurement apparatus may be applied to a scoring assistance system, an in-vehicle system, and the like. An example of the scoring assistance system assists, for example, scoring of a gymnastics performance on the basis of an output of the distance measurement apparatus. In this case, the measurement object 100 is a gymnast, and the scoring may be performed by the computer 4 illustrated in FIG. 4 executing a scoring program, for example. It is sufficient if the computer 4 obtains skeleton information of the gymnast using a well-known method on the basis of the three-dimensional data and the distance image from the arithmetic circuit 5. Since the skeleton information of the gymnast includes a three-dimensional position of each joint of the gymnast in each frame, it is possible to recognize elements of a gymnastics performance from the skeleton information to score the gymnastics performance from a perfection level of the elements.

Since a moving speed of the gymnast is high in the case of the gymnastics performance, an angle of view of the distance measurement apparatus needs to be controlled according to a position of the gymnast. According to each of the embodiments described above, even when an angle of view is changed by shifting a center angle of a scanning angle range in the vertical direction according to the movement of the gymnast, the drive frequency f_{d} of the drive signal does not fluctuate on the resonance drive side the two-dimensional MEMS mirror. Furthermore, on the resonance drive side of the two-dimensional MEMS mirror, the drive frequency f_{d} of the drive signal does not fluctuate regardless of a temperature and a position within the screen. Accordingly, a size and a position of the gymnast in the vertical direction do not change, and the screen distortion caused by the fluctuation of the resonance frequency fₓ of the drive signal may be suppressed. Furthermore, since the drive frequency f_{d} of the drive signal does not fluctuate, for example, it is possible to synchronously operate a plurality of distance measurement apparatuses. As a result, deterioration in the measurement accuracy of the distance measurement apparatus may be suppressed even when the gymnast moves, and by using an output of such a distance measurement apparatus, it becomes possible to perform scoring of the gymnastics performance highly accurately, and to improve reliability of the scoring assistance system.

An example of the in-vehicle system recognizes, for example, a position, a type, and the like of the measurement object 100 in front of a vehicle on the basis of an output of the distance measurement apparatus. In this case, examples of the type of the measurement object 100 include a pedestrian, another vehicle, and the like, and the measurement object 100 may be recognized by the computer 4 executing a recognition program, for example. It is sufficient if the computer 4 obtains shape information of the measurement object 100 using a well-known method on the basis of the three-dimensional data and the distance image from the arithmetic circuit 5. Since the shape information of the measurement object 100 includes a three-dimensional position of each part of the measurement object 100 in each frame, it is possible to recognize the position, the type, and the like of the measurement object 100 from the shape information to determine an approaching degree, a level of danger, and the like. Since the drive frequency f_{d} of the drive signal does not fluctuate on the resonance drive side of the two-dimensional MEMS mirror regardless of the temperature, the position within the screen, and the angle-of-view change, it becomes possible to suppress the screen distortion caused by the fluctuation of the resonance frequency fₓ of the drive signal. Accordingly, the deterioration in the measurement accuracy of the distance measurement apparatus caused by the screen distortion may be suppressed according to each of the embodiments described above, whereby it becomes possible to recognize the position, the type, and the like of the measurement object 100 highly accurately, and to improve the reliability of the in-vehicle system.

Note that serial numbers assigned to the respective embodiments described above do not represent priority of the preferred embodiments.

While the disclosed distance measurement apparatus, mirror control method, and program have been described above in the embodiments, the present disclosure is not limited to the embodiments described above, and it is needless to say that various modifications, improvements, and substitutions may be made within the scope of the present disclosure.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A distance measurement apparatus of a scanning type provided with a two-dimensional micro electro mechanical system (MEMS) mirror that reflects a laser beam, the distance measurement apparatus comprising:
a first detector that detects a mirror angle of the two-dimensional MEMS mirror and outputs an angular signal that indicates the mirror angle; and
a processor that calculates an amplitude error and a phase error between amplitude and a phase of the angular signal and amplitude and a phase of a reference angle signal, and corrects a resonance drive waveform of a drive signal that drives, of two mutually orthogonal axes of the two-dimensional MEMS mirror, one axis on a resonance drive side on a basis of the amplitude error and the phase error.

2. The distance measurement apparatus according to claim 1, further comprising:
a second detector that detects a temperature of the two-dimensional MEMS mirror, wherein
the processor calculates an amplitude correction value of the angular signal on a basis of the temperature, and calculates the amplitude error between the amplitude of the angular signal corrected by the amplitude correction value and the amplitude of the reference angle signal.

3. The distance measurement apparatus according to claim 2, wherein the first detector and the second detector are incorporated in the two-dimensional MEMS mirror.

4. The distance measurement apparatus according to claim 1, wherein the resonance drive waveform includes a sinusoidal wave.

5. The distance measurement apparatus according to claim 1, wherein the processor is configured to:
obtain first amplitude that corresponds to a peak-to-peak value of the angular signal for each cycle of the angular signal, obtain second amplitude that corresponds to a peak-to-peak value of the reference angle signal for each cycle of the reference angle signal, and obtain the amplitude error between the first amplitude and the second amplitude; and
obtain a first phase that corresponds to one of rising or falling zero crossing of the angular signal for each cycle of the angular signal, obtain a second phase that corresponds to the one of zero crossing of the reference angle signal, and obtain the phase error between the first phase and the second phase.

6. The distance measurement apparatus according to claim 1, wherein
the processor:
obtains a proportional gain K_{pw} and an integral gain K_{iw} and outputs an amplitude command value R_{w} represented by R_{w}=K_{pw}×Δw+K_{iw}×∫Δw where Δw represents the amplitude error;
obtains a proportional gain Kₚₕ and an integral gain Kᵢₕ and outputs a phase command value Rₕ represented by Rₕ=Kₚₕ×Δh+Kᵢₕ×∫Δh where Δh represents the phase error; and
generates, on a basis of the amplitude command value R_{w} and the phase command value Rₕ, a drive signal D(t) represented by D(t)=R_{w}×sin(2×n×f_{d}×t+Rₕ) where t represents a time, n represents a circular constant, and f_{d} represents a drive frequency of the drive signal that drives the axis on the resonance drive side.

7. The distance measurement apparatus according to claim 1, wherein the drive signal that drives another axis of the two axes has a non-resonance drive waveform.

8. A mirror control method of controlling a two-dimensional micro electro mechanical system (MEMS) mirror that reflects a laser beam comprising:
detecting a mirror angle of the two-dimensional MEMS mirror and outputs an angular signal that indicates the mirror angle; and
calculating an amplitude error and a phase error between amplitude and a phase of the angular signal and amplitude and a phase of a reference angle signal, and corrects a resonance drive waveform of a drive signal that drives, of two mutually orthogonal axes of the two-dimensional MEMS mirror, one axis on a resonance drive side on a basis of the amplitude error and the phase error.

9. The mirror control method according to claim 8, wherein
a temperature of the two-dimensional MEMS mirror is detected, and
the amplitude error with the amplitude of the reference angle signal is calculated after the amplitude of the angular signal is corrected on a basis of the temperature.

10. The mirror control method according to claim 8, wherein the resonance drive waveform of the drive signal that drives the axis on the resonance drive side is corrected while a drive frequency of the drive signal is maintained constant.

11. The mirror control method according to claim 8, wherein the resonance drive waveform includes a sinusoidal wave.

12. The mirror control method according to claim 8, further comprising:
obtaining first amplitude that corresponds to a peak-to-peak value of the angular signal for each cycle of the angular signal, obtain second amplitude that corresponds to a peak-to-peak value of the reference angle signal for each cycle of the reference angle signal, and obtain the amplitude error between the first amplitude and the second amplitude; and
obtaining a first phase that corresponds to one of rising or falling zero crossing of the angular signal for each cycle of the angular signal, obtain a second phase that corresponds to the one of zero crossing of the reference angle signal, and obtain the phase error between the first phase and the second phase.

13. The distance measurement method according to claim 8, wherein the drive signal that drives another axis of the two axes has a non-resonance drive waveform.

14. A non-transitory computer-readable recording medium storing a program causing a computer to execute a processing of controlling a two-dimensional micro electro mechanical system (MEMS) mirror that reflects a laser beam, the processing comprising:
detecting a mirror angle of the two-dimensional MEMS mirror and outputs an angular signal that indicates the mirror angle; and
calculating an amplitude error and a phase error between amplitude and a phase of the angular signal and amplitude and a phase of a reference angle signal, and corrects a resonance drive waveform of a drive signal that drives, of two mutually orthogonal axes of the two-dimensional MEMS mirror, one axis on a resonance drive side on a basis of the amplitude error and the phase error.

15. The non-transitory computer-readable recording medium according to claim 14, wherein
a temperature of the two-dimensional MEMS mirror is detected, and
the amplitude error with the amplitude of the reference angle signal is calculated after the amplitude of the angular signal is corrected on a basis of the temperature.

16. The non-transitory computer-readable recording medium according to claim 14, wherein the resonance drive waveform includes a sinusoidal wave.

17. The non-transitory computer-readable recording medium according to claim 14, further comprising:
obtaining first amplitude that corresponds to a peak-to-peak value of the angular signal for each cycle of the angular signal, obtain second amplitude that corresponds to a peak-to-peak value of the reference angle signal for each cycle of the reference angle signal, and obtain the amplitude error between the first amplitude and the second amplitude; and
obtaining a first phase that corresponds to one of rising or falling zero crossing of the angular signal for each cycle of the angular signal, obtain a second phase that corresponds to the one of zero crossing of the reference angle signal, and obtain the phase error between the first phase and the second phase.
